(19) United States
(12) Patent Application Publication
(10) Pub. No.: US 2008/0136814 A1
(43) Pub. Date: Jun. 12, 2008

(54) SYSTEM AND METHOD FOR GENERATING 3-D FACIAL MODEL AND ANIMATION USING ONE VIDEO CAMERA

(76) Inventors: Chang Woo CHU, Daejon (KR); Jae Chul KIM, Daejeon (KR); Ho Won KIM, Daejeon (KR); Jeung Chul PARK, Jeollabuk-Do (KR); Ji Young PARK, Seoul (KR); Seong Jae LIM, Gwangju (KR); Bon Ki KOO, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/945,330

(22) Filed: Nov. 27, 2007

(30) Foreign Application Priority Data
Sep. 17, 2006 (KR) 10-2007-0094263
Dec. 4, 2006 (KR) 10-2006-0121359

(51) Int. Cl. G06T 15/00

(52) U.S. Cl. 345/419

(57) ABSTRACT

Provided are system and method for generating a 3D facial model and animation using one video camera. The system includes a pre-processing part, a facial model generating part, a transferring part, a projecting part, an error calculating part, and a mesh transforming part. The pre-processing part sets correspondence relations with other meshes, generates an average 3D facial model, and generates a geometrical model and a texture dispersion model. The facial model generating part projects the average 3D facial onto an expressionless facial image frame that stares a front side to generate a performer's 3D facial model. The transferring part transfers a 3D facial model template having an animation-controlled model to the performer's 3D facial model to generate the performer's 3D facial model. The projecting part projects the performer's 3D facial model onto a facial animation video frame including a facial expression. The error calculating part calculates an error projected by the projecting part. The mesh transforming part moves or rotationally converts a joint in such a direction as to minimize the error.

### BACKGROUND OF THE INVENTION

1. Field of the Invention

The present invention relates to system and method for generating a 3 dimension (D) facial model and animation using one video camera, and more particularly, to system and method for generating a 3D facial model and animation using one video camera, including modeling a performer's 3D face from video, transferring a template model to which an animation control model has been set to the modeled face, projecting a facial model transformed by controlling a joint of the transferred model to the video to find a joint movement value having a minimum error with respect to a video image in order to generate the performer's facial acting shot by one video camera in 3D animation.

2. Description of the Related Art

For a method for generating a 3D facial model, there is a method for scanning a face in 3-dimensionally. However, a 3D model generated using this method not only has noises but also the size of data is too large to be used in actual animation, and features for animation disappear.

Actually, a manual operation by an experienced designer is preferred most and a method for scanning a face in 3-dimensionally is used for a reference purpose only. Besides, for a method for generating a 3D model from one photo, there is a 3D morphable model. This method pre-processes a 3D-scanned face database (DB) to generate a 3D average facial model, and generates a geometrical model and a dispersion model of texture through principal component analysis (PCA). This average facial model is projected onto an image to find a geometrical model minimizing a difference between a generated image and an input image, a coefficient regarding a principal component of texture, and a camera parameter and a rendering parameter for projection. A 3D model for a figure in an input image is generated by linear sum of the average 3D model and the principal component.

For a method for animating a 3D-modeled face, there are an example-based method, and a method using a facial motion capture. The example-based method produces in advance 3D models of various expressions of a model to be animated, and generates a new expression using combination of these 3D models. At this point, the 3D models of the various expressions produced in advance are called blend shapes. According to the method using the facial motion capture, a performer performs facial expressions with tens of markers attached on the performer's face, 3D movements of these markers are captured, and the captured 3D movements are converted into animation data and used. These methods are currently widely used, but lots of manual operations by experienced artists are consumed.

### SUMMARY OF THE INVENTION

Accordingly, the present invention is directed to system and method for generating a 3D facial model and animation using one video camera, which substantially obviate one or more problems due to limitations and disadvantages of the related art.

It is an object of the present invention to provide a method for reproducing a performer's facial expression moving image shot by one video camera in the form of 3D animation.

It is another object of the present invention to provide system and method for generating a 3D facial model and animation using one video camera, including generating the performer's a 3D facial model from an expressionless facial frame staring a front side, transferring a template model to which an animation-controlled model has been set to the generated model, and generating the performer's 3D facial model having the animation-controlled model.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a system for generating a 3 dimension (D) facial model and animation using one video camera, the system including: a pre-processing part for setting correspondence relations with other meshes with respect to all vertexes of a 3D facial mesh input through a 3D facial database (DB), generating an average 3D facial model, and generating a geometrical model and a texture dispersion model through principal component analysis (PCA) of a covariance matrix between the average 3D facial model and a facial model; a facial model generating part for projecting the average 3D facial model generated by the pre-processing part onto an expressionless facial image frame of facial expression moving images input from a video camera, that stares a front side to generate a performer's 3D facial model; a transferring part for transferring a 3D facial model template having an animation-controlled model to the performer's 3D facial model generated by the facial model generating part to generate the performer's 3D facial model having the animation-controlled model; a projecting part for projecting the performer's 3D facial model having the animation-controlled model transferred by the transferring part onto a facial animation video frame including a facial expression; an error calculating part for calculating an error generated by projection of the projecting part; and a mesh transforming part for moving or rotationally converting a joint in such a direction as to minimize the error calculated by the error calculating part to transform a mesh.

In another aspect of the present invention, there is provided a method for generating a 3 dimension (D) facial model and animation using one video camera, the method including the steps of: a pre-processing step of setting correspondence relations with other meshes with respect to all vertexes of a 3D facial mesh input through a 3D facial database (DB), generating an average 3D facial model, and generating a geometrical model and a texture dispersion model through principal component analysis (PCA) of a covariance matrix between the average 3D facial model and a facial model; and an animation forming step of transferring a 3D facial model template having an animation-controlled model to a performer's 3D facial model generated by a facial model generating part, projecting the performer's 3D facial model having the animation-controlled model to a facial animation video frame including a facial expression to calculate an error, and moving or rotationally converting a joint in such a direction as to minimize the error to transform a mesh.

According to the present invention, a performer's facial expression can be easily generated in the form of 3D animation from facial expression moving images shot by one video camera.

Also, according to the present invention, a performer's facial animation data can be easily transferred to a virtual performer's facial expression.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating the construction of a system for generating 3D animation according to an embodiment of the present invention;

FIG. 2 is a block diagram illustrating the construction of a face modeler according to an embodiment of the present invention;

FIG. 3 is a flowchart illustrating a process for generating a performer's 3D facial model using a moving image shot by one vide camera;

FIG. 4 is an exemplary view illustrating a 3D facial model template having an animation-controlled model according to an embodiment of the present invention; and

FIG. 5 is an exemplary view illustrating a mouth of a facial model scanned in 3D according to an embodiment of the present invention.

### DETAILED DESCRIPTION OF THE INVENTION

Reference will now be made in detail to the preferred embodiments of the present invention, examples of which are illustrated in the accompanying drawings.

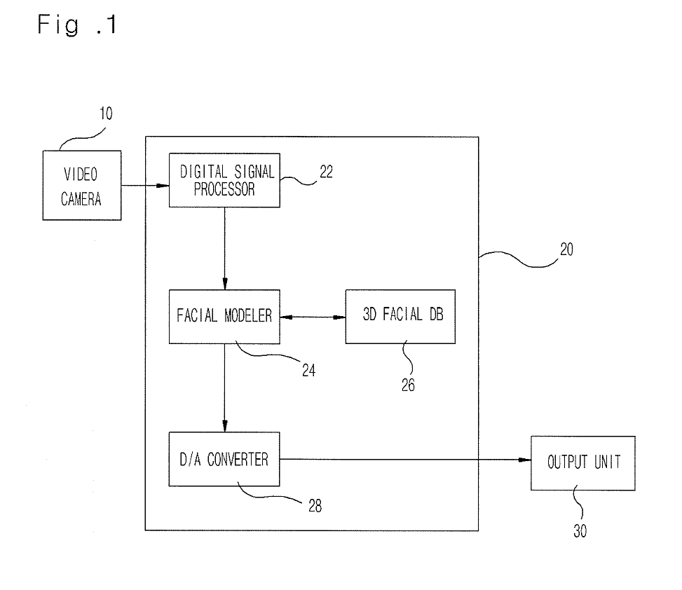

FIG. 1 is a block diagram illustrating the construction of an apparatus for generating 3D animation according to an embodiment of the present invention.

Referring to FIG. 1, the apparatus roughly includes a video camera 10, a computer 20, and an output unit 30. Also, the computer 20 includes a digital signal processor 22, a facial modeler 24, a 3D facial DB 26, and a digital-to-analog (D/A) converter 28.

First, the video camera 10 serves as an input unit and shoots a moving performer's image to generate a moving image thereof.

The computer 20 processes a performer's moving image input through the video camera 10 to produce the image in the form of animation. Meanwhile, in the case where the above-descried video camera 10 is a digital device, information obtained by the video camera 10 is consequently input internally in the form of digital data, so that a separate A/D converter is not needed.

The digital signal processor 22 receives a performer's facial expression moving image transmitted from the video camera 10, and converts the received analog 3D facial expression moving image into digital signals represented with 0 and 1 so that the image can be processed by mathematical operation. The digital signal processor 22 can prevent distortion or a loss of a signal.

The facial modeler 24 receives a digitally processed performer's moving image to model the performer's 3D face for each frame. A face is modeled for each frame, so that a 3D facial model and geometrical model are generated. An animation image of a 3D face is generated using a 3D facial model template 500 having an animation-controlled model, a 3D facial model, and a geometrical model.

The D/A converter 28 converts an animation image of a 3D face processed by the facial modeler 24 into an analog signal that can be displayed through the output unit 30.

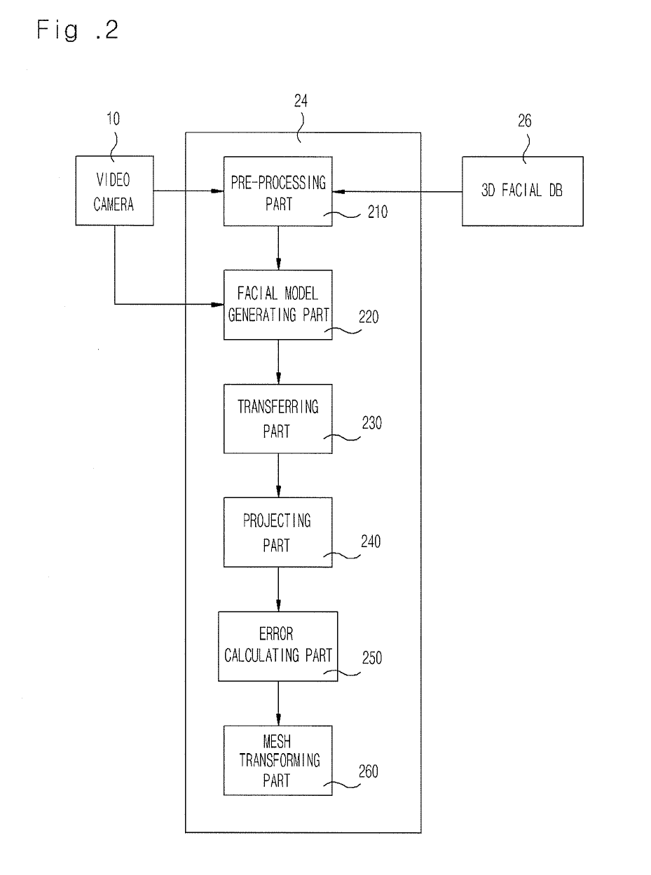

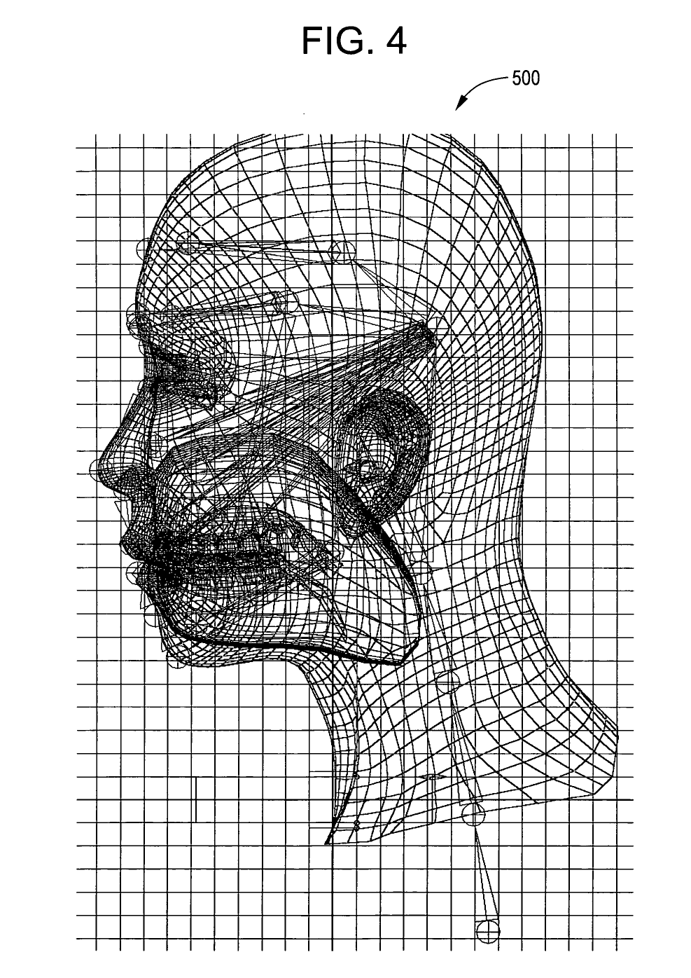

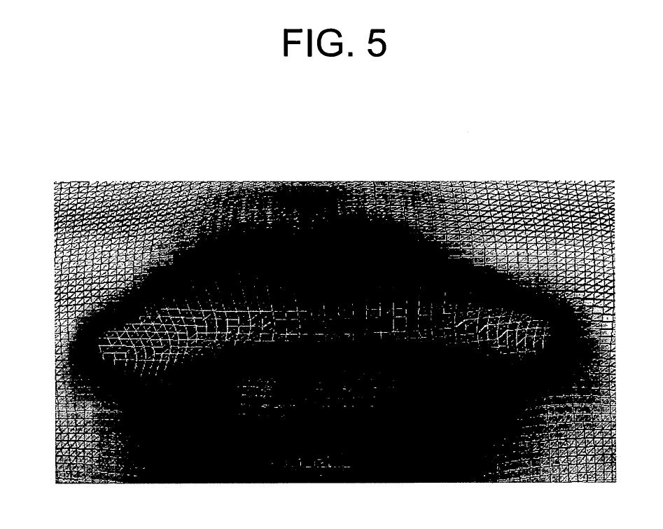

FIG. 2 is a block diagram illustrating the construction of a face modeler according to an embodiment of the present invention, FIG. 4 is an exemplary view illustrating a 3D facial model template having an animation-controlled model according to an embodiment of the present invention, and FIG. 5 is an exemplary view illustrating a mouth of a facial model scanned in 3D according to an embodiment of the present invention.

Referring to FIGS. 2, 4, and 5, the facial modeler 24 includes a pre-processing part 210, a facial model generating part 220, a transferring part 230, a projecting part 240, an error calculating part 250, and a mesh transforming part 260.

The pre-processing part 210 sets correspondence relations with other meshes with respect to all vertexes of a 3D facial DB 26, and generates an average 3D facial model through averaging coordinates and colors of corresponding vertexes. Also, the pre-processing part 210 generates variance models of the geometry and texture through PCA of a covariance matrix between an average facial model and a facial model of the 3D facial DB 26.

The facial model generating part 220 sets correspondence relations with other meshes with respect to all vertexes of a 3D facial mesh input through the video camera 10 if the pre-processing part 210 would be omitted. The facial model generating part 220 projects the average 3D facial model generated by the pre-processing part onto an expressionless facial image frame of facial expression moving images input from the video camera 10, that stares a front side to generate a performer's 3D facial model having a minimum error with respect to a video image. At this point, the variance models of the geometry and the texture are used to fit the average 3D facial image onto the facial expression moving image. As a result, the facial model generated by the facial model generating part 220 is a performer's 3D facial model including texture.

Procedures processed by the pre-processing part 210 and the facial model generating part 220 can be replaced by an existing 3D face scanning method. According to the present invention, a 3D model can be simply generated even using only an image shot by one video camera, and 3D facial scanning does not need to be performed whenever a facial animation object changes.

Meanwhile, though the performer's 3D facial model generated by the facial model generating part 220 has the same shape as that of the performer, the 3D facial model is not yet suitable for animation.

The transferring part 230 transfers the 3D facial model template 500 having an animation-controlled model of FIG. 4 to the performer's 3D facial model generated by the facial model generating part 220 to generate the performer's 3D facial model having the animation-controlled model. At this point, the 3D facial model template 500 having the animation-controlled model is transferred to the performer's 3D facial model by the transferring part 230 using correspondence relation between two meshes of facial features that do not move with respect to a facial expression change.

Also, the model transferred by the transferring part 230 can transform the face through movement and rotation conversion of a joint. For example, when a user intends to open the mouth of a model generated by the facial model generating part 220, the mouth of the model generated by the facial model generating part 220 has a vague boundary between an upper lip and a lower lip of a mesh as illustrated in FIG. 5, so that the mouth cannot be opened. However, in a face obtained by transferring the 3D facial model template having the animation-controlled model to the performer's 3D facial model through the transferring part 230, a mouth can be opened through rotation of a joint moving a chin, and surroundings of an eye and a nose can be changed.

The animation-controlled model includes a skeleton having a hierarchical structure for generating facial expression, a joint, which is an endpoint of the skeleton, and weight representing a degree of an influence the joint has on surrounding vertexes. When the joint moves, coordinates of all vertexes are recalculated according to the animation-controlled model, so that a new facial expression is generated.

The projecting part 240 projects the performer's 3D facial model having the animation-controlled model that has been transferred by the transferring part 230 and has completed preparation for facial animation onto a facial animation video frame including facial expression.

The error calculating part 250 calculates an error between the projected image from the projecting part 240 and a facial animation video frame including a facial expression.

The mesh transforming part 260 translates and rotates a joint in such a direction as to minimize the error calculated by the error calculating part 250 to transform a mesh.

At this point, the operations of the error calculating part 250 and the mesh transforming part 260 are repeatedly performed on all the frames of a video containing a facial expression to generate animation, so that 3D animation that is the same as performance of an entire video can be generated.

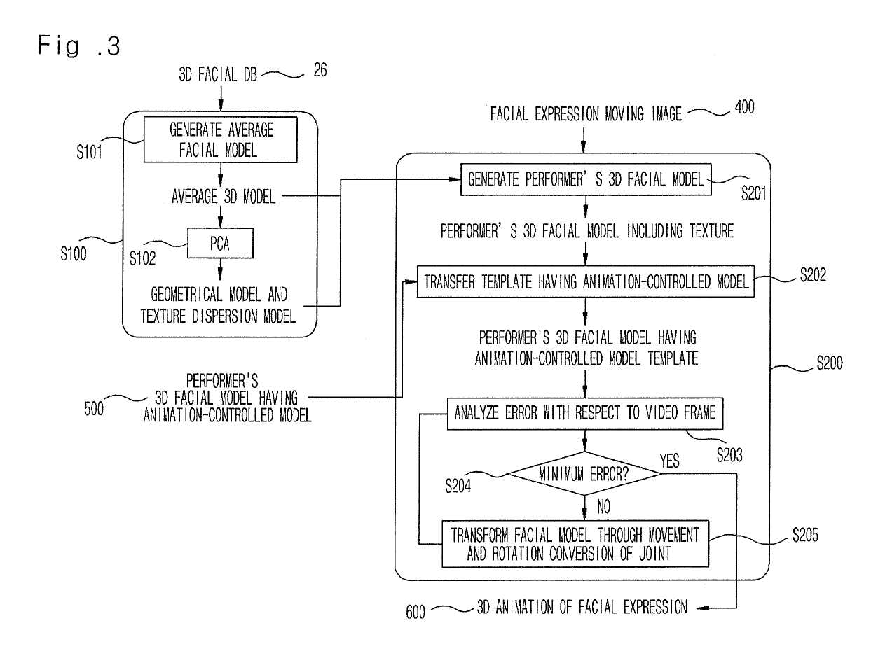

FIG. 3 is a flowchart illustrating a process for generating a performer's 3D facial model using a moving image shot by one vide camera.

Referring to FIG. 3, the steps of the present invention include step S100 of processing at a pre-processor 210, and step S200 of generating animation.

First, the pre-processor 210 receives facial mesh information from 3D facial DB 24 to set correspondence relation with other meshes with respect to all the vertexes of a facial mesh, and generates an average 3D facial model by averaging coordinates and colors of corresponding vertexes (S101).

The pre-processor 210 generates a geometrical model and a texture dispersion model through PCA of a covariance matrix between an average facial model and a facial model of a 3D facial DB 26 (S102). Meanwhile, steps S101 and S102 are included in S100.

The facial model generating part 220 projects an average 3D facial model onto an expressionless facial model frame of facial expression moving images obtained by the video camera 10, that stares a front side to generate a performer's 3D facial model including texture having a minimum error with respect to a video image (S201). During projection, the geometrical model and the texture distribution model obtained in S102 are used.

Meanwhile, step S100 and step S201 of generating the performer's 3D facial model can be replaced by an existing 3D facial scanning method, but according to the present invention, a 3D model can be generated even using only an image shot by one video camera without shooting a side face and a back view, and a 3D face does not need to be scanned whenever a facial animation object changes.

Though the performer's 3D facial model generated in S201 has the same shape as that of the performer, it is not yet suitable for animation. The 3D facial model template 500 having the animation-controlled model illustrated in FIG. 4 is transferred to the 3D facial model generated in step S201, so that the performer's 3D facial model having the animation-controlled model is generated (S202). At this point, in step S202, the transferring part 230 transfers the 3D facial model template 500 having the animation-controlled model to the performer's 3D facial model using correspondence relation between two meshes of a face in facial features not moving with respect to facial expression change.

The performer's 3D facial model having the animation-controlled model and generated in step S202 can be transformed through translational and rotational conversion of a joint. For example, when a user intends to open the mouth of a model generated in step S201, the mouth of the model has a vague boundary between an upper lip and a lower lip of a mesh as illustrated in FIG. 5, so that the mouth cannot be opened. However, in the performer's 3D facial model having the animation-controlled model transferred in step S202, a mouth can be opened through translating a joint in the chin.

An error between an image generated by projecting the performer's 3D facial model from step S202, and a video frame including facial expression is calculated (S203).

Whether the error calculated in S203 is located within a minimum error range is judged (S204).

When the error is located within the minimum error range as a result of the judgment in step S204, 3D animation of facial expression is made and a process is ended. That is, the 3D animation of the facial expression is output through the D/A converter 28, and the process is ended.

When the error is located outside the minimum error range as a result of the judgment in step S204, a joint is moved and rotated in such a direction as to minimize the error to change a mesh (S205). After step S205, step S203 is performed and repeated until the error is located within the minimum error range, and animation corresponding to the frame is generated when the error is minimized.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for generating a 3 dimension (D) facial model and animation using one video camera, the system comprising:
a facial model generating part for generating a performer's 3D facial model onto an expressionless facial image frame of facial expression moving images input from a video camera, that stares a front side;
a transferring part for transferring a 3D facial model template having an animation-controlled model to the performer's 3D facial model generated by the facial model generating part to generate the performer's 3D facial model having the animation-controlled model;
a projecting part for projecting the performer's 3D facial model having the animation-controlled model transferred by the transferring part onto a facial animation video frame including a facial expression;
an error calculating part for calculating an error between the projected image from the projecting part and a facial animation video frame including a facial expression; and
a mesh transforming part for translating and rotating a joint in such a direction as to minimize the error calculated by the error calculating part to transform a mesh.

2. A system of claim 1, further comprising a pre-processing part for setting correspondence relations with other meshes with respect to all vertexes of a 3D facial DB, generating an average 3D facial model, and generating variance models of the geometry through principal component analysis (PCA) of a covariance matrix between the average 3D facial model and facial models in DB.

3. The system of claim 1, wherein processes performed by the facial model generating part are replaced by existing 3D facial scanning.

4. The system of claim 1, wherein operations of the error calculating part and the mesh transforming part are repeated for all video frames containing facial expression to generate animation.

5. The system of claim 2, wherein operations of the error calculating part and the mesh transforming part are repeated for all video frames containing facial expression to generate animation.

6. The system of claim 3, wherein operations of the error calculating part and the mesh transforming part are repeated for all video frames containing facial expression to generate animation.

7. A method for generating a 3 dimension (D) facial model and animation using one video camera, the method comprising the steps of:
a facial model generating step of generating a performer's 3D facial model by facial model generating part onto an expressionless facial image frame of facial expression moving images input from a video camera, that stares a front side; and
an animation forming step of transferring a 3D facial model template having an animation-controlled model to a performer's 3D facial model generated by a facial model generating part, projecting the performer's 3D facial model having the animation-controlled model to a facial animation video frame including a facial expression to calculate an error, and moving or rotationally converting a joint in such a direction as to minimize the error to transform a mesh.

8. The method of claim 7, wherein the animation forming step comprises:
projecting the average 3D facial model onto an expressionless facial model frame of moving images including facial expression obtained by a video camera, that stares a front side to generate a performer's 3D facial model;
transferring the 3D facial model template having the animation-controlled model onto the 3D facial model to generate the performer's 3D facial model having the animation-controlled model;
calculating an error between an image generated by projecting the performer's 3D facial model onto a facial animation video frame including facial expression, and a video frame including facial expression;
judging whether the calculated error is located within a minimum error range;
when the calculated error is located within the minimum error range as a result of the judgment, producing 3D animation of facial expression; and
when the calculated error is located outside the minimum error range as a result of the judgment, moving and rotationally converting a joint in such a direction as to minimize the error to transform a mesh.

9. The method of claim 7, further comprising:
a pre-processing step of setting correspondence relations with other meshes with respect to all vertexes of a 3D facial DB, generating an average 3D facial model, and generating a variance models of the geometry and a texture dispersion model through principal component analysis (PCA) of a covariance matrix between the average 3D facial model and a facial model.

10. The method of claim 8, wherein the step of projecting the average 3D facial model onto the expressionless facial model frame are replaced by 3D facial scanning.

11. The method of claim 8, wherein the step of calculating, the step of judging, the step of producing the animation, and the step of transforming the mesh are repeated until the error is located within the minimum error range.

12. The method of claim 7, wherein the step of transferring the 3D facial model template having the animation-controlled model onto the 3D facial model comprises transferring the 3D facial model template having the animation-controlled model onto the 3D facial model using correspondence relations between two meshes of features of a face, the features not moving with respect to facial expression change.

13. The method of claim 8, wherein the step of transferring the 3D facial model template having the animation-controlled model onto the 3D facial model comprises transferring the 3D facial model template having the animation-controlled model onto the 3D facial model using correspondence relations between two meshes of features of a face, the features not moving with respect to facial expression change.
